(19) United States
(12) Patent Application Publication
(10) Pub. No.: US 2019/0237027 A1
(43) Pub. Date: Aug. 1, 2019

(54) COLOR TEMPERATURE ADJUSTMENT DEVICE AND MTHOD OF LIQUID CRYSTAL PANEL AND LIQUID CRYSTAL PANEL

(71) Applicants: Shenzhen China Star Optoelectronics Technology Co., Ltd, Shenzhen (CN); Wuhan China Star Optoelectronics Technology Co., Ltd, Wuhan (CN)

(72) Inventors: Jinjie ZHOU, Shenzhen (CN); Yujie BAI, Shenzhen (CN); Xingling GUO, Shenzhen (CN)

(73) Assignees: Shenzhen China Star Optoelectronics Technology Co., Ltd, Shenzhen (CN); Wuhan China Star Optoelectronics Technology Co., Ltd, Wuhan (CN)

(21) Appl. No.: 16/377,566

(22) Filed: Apr. 8, 2019

Related U.S. Application Data
(63) Continuation-in-part of application No. 15/310,680, filed on Nov. 11, 2016.

(51) Int. Cl. G09G 3/34; G09G 3/36

(52) U.S. Cl. CPC G09G 3/3406; G09G 2360/145; G09G 2320/0666; G09G 3/3607

(57) ABSTRACT

Provided are a color temperature adjustment device and a method for adjusting a color temperature of a liquid crystal panel. A sensor senses the color temperature of the liquid crystal panel. A controller generates a control signal in response to a difference between the sensed color temperature and a predetermined value being greater than a threshold. A backlight circuit is operable to adjust a driving current that drives a backlight unit of the liquid crystal panel in response to the control signal. When the difference is positive, the control signal reduces the driving current; and when the difference is negative, the control signal enhances the driving current.

### CROSS REFERENCE TO RELATED APPLICATIONS

This is a continuation-in-part of co-pending U.S. patent application Ser. No. 15/310,680, filed on Nov. 11, 2016, which is a national stage of PCT Application No. PCT/CN2016/089744, filed on Jul. 12, 2016, claiming foreign priority of Chinese Patent Application No. 201610291088.6 filed on May 4, 2016.

### BACKGROUND OF THE DISCLOSURE

### 1. Field of the Disclosure

The present disclosure relates to a liquid crystal display technical field, and in particular to a color temperature adjustment device and a method of a liquid crystal panel and a liquid crystal panel.

### 2. The Related Arts

The liquid crystal panel of the existing three-color liquid crystal display comprises a plurality of pixels, and each pixel comprises three sub-pixels, which are a red sub-pixel, a green sub-pixel and a blue sub-pixel. Alone with the development of the technology, four-color liquid crystal display is appeared, each pixel of a liquid crystal panel of a four-color liquid crystal display comprises four sub-pixels, except the three sub-pixels described above, there is also a white (W) sub-pixel. The screen of the liquid crystal display is brighter after increasing the W sub-pixel, and the color of the displayed image becomes more vivid. Before a product of liquid crystal panel is shipped, it need to measure color gamut, color temperature and color coordinates and other parameters of the liquid crystal panel. The color coordinate (for example white color coordinate) of the manufactured liquid crystal panel may drift, but this drift cannot be corrected, the color temperature and color coordinate are corresponded, therefore, to provide a color temperature adjustment device and method of the liquid crystal panel is required, in order to correct the drift of the color coordinate through adjusting the color temperature.

### SUMMARY OF THE DISCLOSURE

In order to overcome the deficiencies of the prior art, exemplary embodiments of the present disclosure provide a method and a device which can adjust the color temperature of the liquid crystal panel.

In an aspect of the present disclosure, an embodiment provides a color temperature adjustment device of a liquid crystal panel. Th color temperature adjustment device comprises: a sensor, sensing the color temperature of the liquid crystal panel; a controller, generating a control signal based on the sensed color temperature; and a backlight integrated circuit, adjusting a driving current used to drive a backlight unit of the liquid crystal panel based on the control signal.

Optionally, the controller comprises: a comparison module, comparing a difference value between the sensed color temperature and a predetermined color temperature with a threshold value; and a signal generation module, generating a control signal when the difference value is larger than the threshold value.

Optionally when the difference value is larger than the threshold value and is positive, the signal generation module generates a control signal which is used to reduce the driving current; when the difference value is larger than the threshold value and is negative, the signal generation module generates a control signal which is used to enhance the driving current.

Optionally, the color temperature adjustment device also comprises: a communication unit, which is in communication with an external device.

Optionally, the backlight unit comprises at least an assembly of light emitting diodes, which comprises a first light emitting diode, a second light emitting diode, a third light emitting diode and a fourth light emitting diode which are arranged in two columns, wherein the first light emitting diode and the second light emitting diode are sequentially arranged in a first column; the third light emitting diode and the fourth light emitting diode are sequentially arranged in a second column; a negative electrode of the fourth light emitting diode is connected with a positive electrode of the first light emitting diode; and a negative electrode of the second light emitting diode is connected with a positive electrode of the third light emitting diode.

In another aspect of the present disclosure, an embodiment provides a method for adjusting a color temperature of a liquid crystal panel. The method comprises: (A) sensing the color temperature of the liquid crystal panel; (B) generating a control signal based on the sensed color temperature; and (C) adjusting a driving current that drives a backlight unit of the liquid crystal panel based on the control signal.

Optionally, the step of generating a control signal based on the sensed color temperature comprises: comparing a difference value between the sensed color temperature and a predetermined color temperature with a threshold value; and generating a control signal when the difference value is larger than the threshold value.

Optionally, when the difference value is larger than the threshold value and is positive, the control signal is generated to reduce the driving current; and when the difference value is larger than the threshold value and is negative, the control signal is generated to enhance the driving current.

Optionally, the backlight unit comprises at least one assembly of light emitting diodes, which comprises a first light emitting diode, a second light emitting diode, a third light emitting diode and a fourth light emitting diode which are arranged in two columns, wherein the first light emitting diode and the second light emitting diode re sequentially arranged in a first column; the third light emitting diode and the fourth light emitting diode are sequentially arranged in a second column; a negative electrode of the fourth light emitting diode is connected with a positive electrode of the first light emitting diode; and a negative electrode of the second light emitting diode is connected with a positive electrode of the third light emitting diode.

According to the method and the device provided by the exemplary embodiments of the present disclosure, it is possible to correct the drift of the color coordinate through adjusting the color temperature of the liquid crystal panel, enhancing the performance of the liquid crystal panel, optimizing the display effect of the liquid crystal panel.

The following description will partially elaborate the other aspects and/or advantages of the present disclosure, and a portion will be apparent through the description, or may be known through the embodiments of the present disclosure.

### BRIEF DESCRIPTION OF THE DRAWINGS

A description of embodiments of the present disclosure will be provided below with reference to the attached drawings for better illustrating and explaining the above and other purposes and advantages of the present disclosure, wherein:

FIG. 1 is a block diagram of a color temperature adjustment device of a liquid crystal panel according to an embodiment of the present disclosure;

FIG. 2 is a schematic diagram of a backlight module according to an embodiment of the present disclosure;

FIG. 3 is a schematic diagram of a backlight module according to another embodiment of the present disclosure; and

FIG. 4 is a flow chart of a color temperature adjustment method of a liquid crystal panel according to an embodiment of the present disclosure.

### DETAILED DESCRIPTION OF THE PREFERRED EMBODIMENTS

Exemplary embodiments of the present disclosure will now be described in detail. The embodiments are shown in the drawings, where the same reference numerals indicate the same portions. The following is a description of the embodiments with reference being had to the drawings, in order to explain the present disclosure.

It is noted that the described liquid crystal panel comprises a plurality of pixels, and each pixel comprises a plurality of sub-pixels (for example three sub-pixels or four sub-pixels). Namely, the present disclosure can be applied to three-color liquid crystal displays, four-color liquid crystal displays, or liquid crystal displays of more colors.

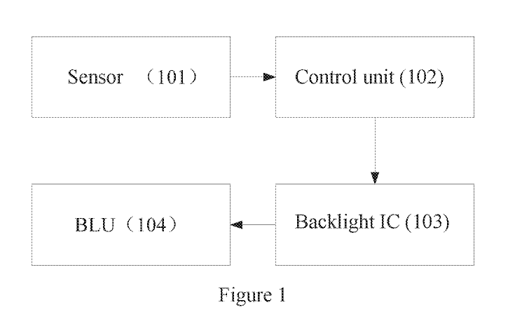

FIG. 1 is a block diagram of a color temperature adjustment device of a liquid crystal panel according to an embodiment of the present disclosure. In the present embodiment, the liquid crystal panel comprises a substrate and a backlight unit, BLU. The backlight unit comprises a plurality of light emitting diodes, LEDs, or organic light emitting diodes, OLEDs, in order to irradiate the substrate with light for displaying images on the liquid crystal panel. The light emitting diode is taken as an example for illustration herein.

As shown in FIG. 1, the color temperature adjustment device according to the embodiment of the present disclosure comprises: a sensor 101, a controller 102, and a backlight integrated circuit, IC, 103.

The sensor 101 is used to sense a color temperature of the liquid crystal panel. The sensor 101 can be a color temperature meter or a chromathermograph, which measures emitted light of the liquid crystal panel during displaying.

The controller 102 is used to generate a control signal based on the sensed color temperature. The controller 102 can be a single-core processor, a dual-core processor, or a multi-core processor. The controller 102 comprises: a comparison module, which is used to compare a difference value between the sensed color temperature and a predetermined color temperature with a threshold value; and a signal generation module, which is used to generate a control signal when the difference value is larger than the threshold value.

As an example, when the difference value is larger than the threshold value and is positive, the signal generation module generates a control signal which is used to reduce the driving current; when the difference value is larger than the threshold value and is negative, the signal generation module generates a control signal which is used to enhance the driving current.

The backlight integrated circuit 103 is used to adjust a driving current used to drive a backlight unit 104 of the liquid crystal panel based on the control signal. The backlight integrated circuit 103 can be independent of the liquid crystal panel, or can alternatively be integrated into the backlight integrated circuit in the liquid crystal panel.

In an example, the backlight integrated circuit 103 adopts a backlight integrated circuit that is integrated in the liquid crystal panel. Under this circumstance, the liquid crystal panel comprises a storage. The color temperature adjustment device of the embodiment of the present disclosure can be used to adjust the backlight unit of the liquid crystal panel. When the difference value between the color temperature sensed by the sensor and the predetermined color temperature is larger than the threshold value, the driving current is adjusted through the control signal, until the difference value is less than or equal the threshold value. The storage of the liquid crystal panel stores the driving current when the difference is less than or equal to the threshold value. When the liquid crystal panel is put into operation (for example, starting the liquid crystal), the driving current stored in the storage is used to drive the backlight unit of the liquid crystal panel.

In another example, the backlight integrated circuit 103 adopts a backlight integrated circuit that is independent of the liquid crystal panel. Under this situation, the liquid crystal panel comprises a backlight integrated circuit and a storage, and the color temperature adjustment may comprise a communication unit. The color temperature adjustment device of the embodiment of the present disclosure can be used to adjust the backlight unit of the liquid crystal panel. When the difference value between the color temperature sensed by the sensor and the predetermined color temperature is larger than the threshold value, the driving current is adjusted through the control signal, until the difference value is less than or equal to the threshold value. When the difference value is less than or equal to the threshold value, the driving current is sent to the liquid crystal panel through the communication unit, and the storage of the liquid crystal panel stores the driving current. When the liquid crystal panel is put into operation (for example, starting the liquid crystal), the backlight integrated circuit of the liquid crystal panel uses the driving current stored in the storage to drive the backlight unit of the liquid crystal panel.

In an example, the communication unit of the color temperature adjustment device is also used to communicate with an external device, such as a personal computer.

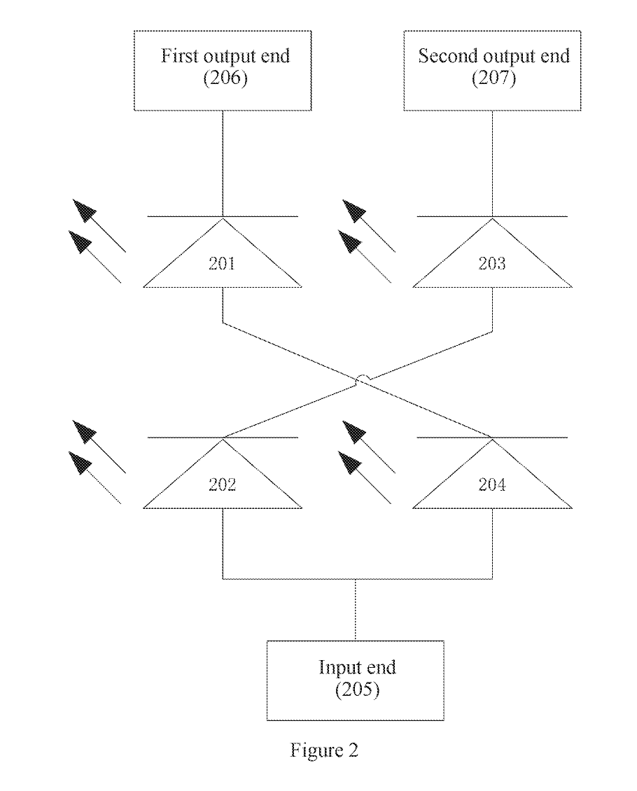

FIG. 2 is a schematic diagram of a backlight module according to an embodiment of the present disclosure.

As shown in FIG. 2, the backlight of the exemplary embodiment comprises at least one input end 205 and at least two output ends 206 and 207, and arranged between the input end 205 and two output ends 206, 207 is an assembly that includes at least a first light emitting diode 201, a second light emitting diode 202, a third light emitting diode 203, and a fourth light emitting diode 204 which are arranged in two column, wherein the first light emitting diode 201 and the second light emitting diode 202 are sequentially arranged in the first column and the third light emitting diode 203 and the fourth light emitting diode 204 are sequentially arranged in the second column, wherein a negative electrode of the fourth light emitting diode 204 is connected with a positive electrode of the first light emitting diode 201; a negative electrode of the second light emitting diode 202 is connected with a positive electrode of the third light emitting diode 203; a positive electrode of the second light emitting diode 202 and a positive electrode of the fourth light emitting diode 204 are connected with the input end 205; and a negative electrode of the first light emitting diode 201 and a negative electrode of the third light emitting diode are respectively connected with the output end 206 and the output end 207.

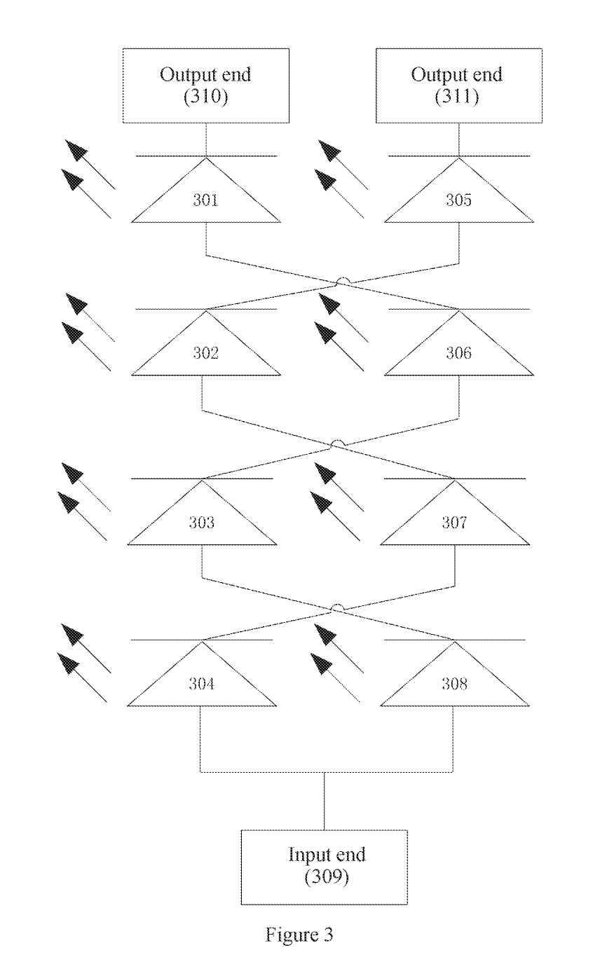

In an example, the four light emitting diode as described above form a light emitting diode assembly. The backlight unit of the exemplary embodiment may comprise at least one (preferably two or three) of such a light emitting diode assembly. The embodiment shown in FIG. 3 comprises a backlight unit that comprises two of such a light emitting diode assembly.

In an example, the output end 206 and the output end 207 are connected with the backlight integrated circuit 103 shown in FIG. 1. The light emitting diodes of the backlight unit can also be arranged in three or more columns, with each column corresponding to an output end. The backlight integrated circuit 103 controls the light emitting diodes in series through the output ends.

FIG. 3 is a schematic diagram of a backlight module of another embodiment of the present disclosure.

As shown in FIG. 3, arranged between an input end 309 and two output ends 310, 311 is a combination of light emitting diodes 301-308, wherein the light emitting diode 304, the light emitting diode 307, the light emitting diode 302, and the light emitting diode 305 are electrically connected in series to form a first series of light emitting diodes and the light emitting diode 308, the light emitting diode 303, the light emitting diode 306, and the light emitting diode 301 are electrically connected in series to form a second series of light emitting diodes; and also, the light emitting diode 304, the light emitting diode 303, the light emitting diode 302, and the light emitting diode 301 are spatially arranged in cascade with each other to made up a first column and the light emitting diode 308, the light emitting diode 307, the light emitting diode 306, and the light emitting diode 305 are spatially arranged in cascade with each other to made up second column.

In other words, for each of the first and second columns of light emitting diodes, odd-numbered light emitting diodes (such as the first and the third ones of the four light emitting diodes making up the first column or the second column) and the even-numbered light emitting diodes (such as the second and the fourth ones of the four light emitting diodes making up the first column or the second column) respectively belong to the first and second series of light emitting diodes, and similarly, for each of the first and second series of light emitting diodes, odd-numbered light emitting diodes (such as the first and the third ones of the four light emitting diodes making up the first series or the second series) and the even-numbered light emitting diodes (such as the second and the fourth ones of the four light emitting diodes making up the first series or the second series) respectively belong to the first and second columns of light emitting diodes.

Specifically, the first light emitting diode 304 of the first column, the second light emitting diode 307 of the second column, the third light emitting diode 302 of the first column, and the fourth light emitting diode 305 of the second column are electrically and sequentially connected, in such an order, between the input end 309 and the output end 310 to form the first series; and the first light emitting diode 308 of the second column, the second light emitting diode 303 of the first column, the third light emitting diode 306 of the second column, and the fourth light emitting diode 301 of the first column are electrically and sequentially connected, in such an order, between the input end 309 and the output end 311 to form the second series. Also, the first light emitting diode 304 of the first series, the second light emitting diode 303 of the second series, the third light emitting diode 302 of the first series, and the fourth light emitting diode 301 of the second series are sequentially arranged, in such an order, to form the first column; and the first light emitting diode 308 of the second series, the second light emitting diode 307 of the first series, the third light emitting diode 306 of the second series, and the fourth light emitting diode 305 of the first series are sequentially arranged, in such an order, to form the second column. With such an arrangement, the light emitting diodes of the first series are alternately arranged in the first and second columns, and the light emitting diodes of the second series are alternately arranged in the second and first columns; and similarly, the light emitting diodes of the first column are alternately included in the first and second series, and light emitting diodes of the second column are alternately included in the second and first series.

In other words, the odd-numbered light-emitting diodes of the first series and the even-numbered light-emitting diodes of the second series are alternately arranged in the first column and the odd-numbered light-emitting diodes of the second series and the even-numbered light-emitting diodes of the first series are alternately arranged in the second column. And, the odd-numbered light-emitting diodes of the first column and the even-numbered light-emitting diodes of the second column are alternately connected in the first series and the odd-numbered light-emitting diodes of the second column and the even-numbered light-emitting diodes of the first column are alternately connected in the second series.

This provides a twisted, mutually-crossing arrangement between the serially-connected light emitting diodes of the first series and the serially-connected light-emitting diodes.

In the embodiments of the present disclosure, each light emitting diode of the backlight unit can be of the same specification or they can be of different specifications. The light emitting diodes are arranged in a crossing configuration and, compared to an arrangement in which the light emitting diodes in the same column are electrically connected in series with each other, the spacing between two adjacent light emitting diodes is increased. When adjustment is made on the light emitting diodes which are in series, an affected region of the liquid crystal panel is increased and this is beneficial to the adjustment of the color temperature of the liquid crystal panel.

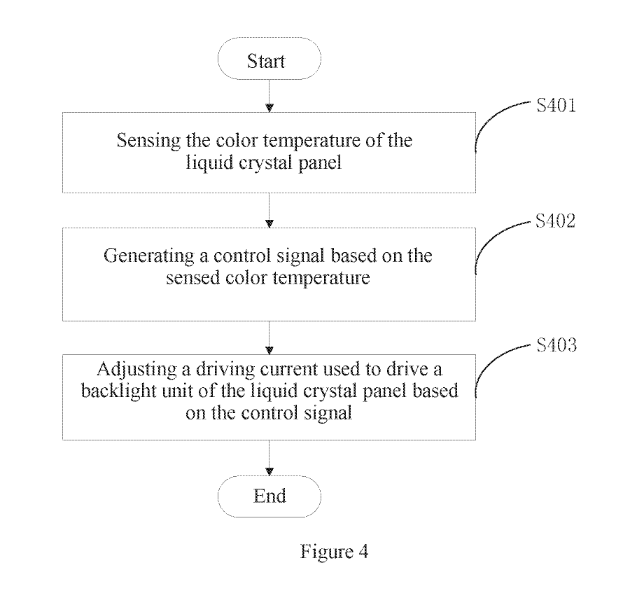

FIG. 4 is a flow chart showing a color temperature adjustment method of a liquid crystal panel according to an embodiment of the present disclosure.

As shown in FIG. 4, in step S401, a color temperature of a liquid crystal panel is sensed. The measurement can be done by measuring light emitting from the liquid crystal panel with a color temperature meter or a chromathermograph.

In step S402, a control signal is generated based on the sensed color temperature. In an example, the step of generating a control signal based on the sensed color temperature comprises: comparing a difference value between the sensed color temperature and a predetermined color temperature with a threshold value; and generating a control signal when the difference value is larger than the threshold value. The control signal can be a pulse width modulated signal.

In an example, when the difference value is larger than the threshold value and is positive, the control signal is generated to reduce a driving current; and when the difference value is larger than the threshold value and is negative, the control signal is generated to enhance the driving current.

In step S403, a driving current used to drive a backlight unit of the liquid crystal panel is adjusted based on the control signal.

Moreover, in another embodiment of the present disclosure, a liquid crystal panel that comprises the backlight unit described above embodiment is provided.

Furthermore, the above described method according to the present disclosure can be implemented as a computer code in a computer readable recording medium. Skilled persons of the art can readily implement the computer code according to the above method. The above described method of the present disclosure will be implemented when the computer code is executed in the computer.

Moreover; each unit in the color temperature adjustment device of the liquid crystal panel according to the exemplary embodiments of the present disclosure can be implemented as hardware components. The processing performed by those skilled in the art according each unit can use FPGA or ASIC to achieve each unit.

The above description is only the specific embodiment in the present invention, be noted that, for those ordinary technical personnel in this art, it also can be improved and modified under the circumstance of without disobeying the present application principle, these improvements and modifications are also considered in the scope of the present application.

What is claimed is:

1. A color temperature adjustment device of a liquid crystal display panel, comprising:
a sensor, which senses a color temperature of the liquid crystal panel provide a sensed color temperature;
a controller; which generates a control signal based on the sensed color temperature; and
a backlight circuit, which is operable to adjust a driving current that drives a backlight unit of the liquid crystal panel based on the control signal, wherein the backlight unit comprises multiple light emitting diodes that are arranged in a first column and a second column, each of which comprises a first number of the light emitting diodes of the multiple light emitting diodes and the first number of light emitting diodes are arranged spatially in cascade and comprises odd-numbered light emitting diodes and even-numbered light emitting diodes, wherein the odd-numbered light-emitting diodes of the first column and the even-numbered light-emitting diodes of the second column are electrically connected, in sequence, to form a first series of light emitting diodes and the odd-numbered light-emitting diodes of the second column and the even-numbered light-emitting diodes of the first column are electrically connected, in sequence, to form a second series of light emitting diodes;
wherein each of the first and second series comprises a second number of the light emitting diodes of the multiple light emitting diodes and the second number of light emitting diodes are electrically connected and comprises odd-numbered light emitting diodes and even-numbered light emitting diodes, wherein the odd-numbered light-emitting diodes of the first series and the even-numbered light emitting diodes of the second series are alternately arranged in the first column and the odd-numbered light-emitting diodes of the second series and the even-numbered light-emitting diodes of the first series are alternately arranged in the second column.

2. The color temperature adjustment device as claimed in claim 1, wherein the controller is operable to determine a difference between the sensed color temperature and a predetermined color temperature and generate the control signal in response to the difference.

3. The color temperature adjustment device as claimed in claim 2, wherein the controller is operable to make comparison between the difference and a threshold such that when the difference is larger than the threshold and is positive, the control signal generated by the controller reduces the driving current that drives the backlight unit; and when the difference is larger than the threshold and is negative, the control signal generated by the controller enhances the driving current that drives the backlight unit.

4. The color temperature adjustment device as claimed in claim 1, wherein the multiple light emitting diodes of the backlight unit comprises eight light emitting diodes and the first number of light emitting diodes comprises four light emitting diodes.

5. The color temperature adjustment device as claimed in claim 4, wherein the second number of light emitting diodes comprises four light emitting diodes.

6. A method for adjusting a color temperature of a liquid crystal panel, comprising:
sensing the color temperature of the liquid crystal panel to generate a sensed color temperature;
generating a control signal in response to the sensed color temperature; and
adjusting a driving current that drives a backlight unit of the liquid crystal panel in response to the control signal, wherein the backlight unit comprises multiple light emitting diodes that are arranged in a first column and a second column, each of which comprises a first number of the light emitting diodes of the multiple light emitting diodes and the first number of light emitting diodes are arranged spatially in cascade and comprises odd-numbered light emitting diodes and even-numbered light emitting diodes, wherein the odd-numbered light-emitting diodes of the first column and the even-numbered light-emitting diodes of the second column are electrically connected, in sequence, to form a first series of light emitting diodes and the odd-numbered light-emitting diodes of the second column and the even-numbered light-emitting diodes of the first column are electrically connected, in sequence, to form a second series of light emitting diodes;
wherein each of the first and second series comprises a second number of the light emitting diodes of the multiple light emitting diodes and the second number of light emitting diodes are electrically connected and comprises odd-numbered light emitting diodes and even-numbered light emitting diodes, wherein the odd-numbered light-emitting diodes of the first series and the even-numbered light-emitting diodes of the second series are alternately arranged in the first column and the odd-numbered light-emitting diodes of the second series and the even-numbered light-emitting diodes of the first series are alternately arranged in the second column.

7. The method as claimed in claim 6, wherein generating a control signal in response to the sensed color temperature comprises:
determining a difference between the sensed color temperature and a predetermined color temperature;
comparing the difference with a threshold; and
generating the control signal when the difference value is larger than the threshold.

8. The method as claimed in claim 7, wherein when the difference is larger than the threshold and is positive, the control signal is generated used to reduce the driving current; and when the difference is larger than the threshold and is negative, the control signal is generated to enhance the driving current.

9. The method as claimed in claim 6, wherein the multiple light emitting diodes of the backlight unit comprises eight light emitting diodes and the first number of light emitting diodes comprises four light emitting diodes.

10. The method as claimed in claim 9, wherein the second number of light emitting diodes comprises four light emitting diodes.
